(19) United States
(12) Patent Application Publication
(10) Pub. No.: US 2005/0259653 A1
(43) Pub. Date: Nov. 24, 2005

(54) System architecture and method for customer flow management

(75) Inventor: Eran Reuveni, Tel Aviv (IL)

Correspondence Address: KATTEN MUCHIN ROSENMAN LLP, 575 MADISON AVENUE, NEW YORK, NY, 10022-2585, US

(73) Assignee: Q-NOMY INC.

(21) Appl. No.: 11/169,843

(22) Filed: Jun. 29, 2005

Related U.S. Application Data
(63) Continuation-in-part of application No. 10/628,833, filed on Jul. 28, 2003.

(51) Int. Cl. H04L 12/56

(52) U.S. Cl. 370/389

(57) ABSTRACT

An improved hardware independent, open-architecture queue management system (QMS) for management of users in a queue, the system including at least one Web-based server for an organization containing the logic and central systems functions. The system also includes a Web client application allowing interaction between the users and the Web Web-based server and accessible through a browser on client workstations and a database installed on a Structured Query Language (SQL) server for record maintenance and interactions with the Web-based server and the client application. The system further includes an announcer server for activating a radio frequency identification (RFID) transmitter carried by each of the users, a survey station kiosk having an RFID receiver, displays to provide queue and marketing information to users and speakers to announce information to the users and an automated an receptionist for issuing tickets to the users.

### CROSS-REFERENCE TO RELATED APPLICATION

This application is a continuation-in-part of U.S. application Ser. No. 10/628,833, titled “System Architecture and a Method for Customer Flow Management,” filed Jul. 28, 2003, which is incorporated herein by reference.

### FIELD OF THE INVENTION

The present invention relates to systems and methods for customer/user flow management. More particularly, the present invention relates to an improved integrated Web system architecture and an improved hardware independent method for queue management applications.

### BACKGROUND OF THE INVENTION

Queue Management Systems (QMS) is a term widely used to describe traditional solutions for Customer Reception and Flow Management (CRFM). Very simple QMS's are often referred to as “Take-a-Ticket” systems. CRFM consists of several elements which may be generally grouped into customer management, agent management, interaction management and service level management.

Customer management covers such topics as customer identification, ticketing, and guidance, e.g. “customer 123 go to room 456.” These topics are handled well by existing QMS's, except where customer identification requires complex integration with enterprise databases. QMS's are also limited in the use of customer guidance tools, such as displays, speakers, etc., which are usually supplied by the QMS vendor.

Agent management covers topics such as staffing and productivity monitoring. These topics are only handled by the most advanced QMS's.

Interaction management covers features such as appointment management and screen pop-ups, and requires seamless integration with enterprise CRFM software and Web applications. Existing QMS's are closed architecture systems, making them very difficult to integrate.

A .Net application is developed using developer tools, such as Microsoft Visual Studio for .NET (hereinafter, the “VS .Net”), which provides an integrated development environment (IDE) for maximizing programmer productivity with the .NET framework. The VS .Net allows a programmer to create, compile, debug and execute a .Net application using one or a combination of the above mentioned programming languages. The VS .Net framework provides developers with a unified, object-oriented, hierarchical, and extensible set of class libraries. By creating a common set of Applications Programming Interfaces (API's) across all programming languages, the common language runtime enables cross-language inheritance, error handling and debugging.

Developments in the art include U.S. Pat. No. 4,675,647 to Salin, et al., 1987, whose disclosure is incorporated herein by reference, teaches a system comprising a turn-number device with memory facilities and with the possibility for selection of a service point, an information unit connected to the device and designed to be able to indicate which mechanically ticketed turn-number is to be served next, and at which service point service is to be given.

U.S. Pat. No. 6,529,786 to Sim published in March, 2003, whose disclosure is incorporated herein by reference, provides a queue management system which allows people who wish to queue to be free to undertake other activities. The time involved in physically queuing can be drastically reduced to perhaps a few minutes. The system maintains the place of users in each queue and informs them when they should physically join the queue.

Service level management, available in advanced QMS, requires constant monitoring of waiting times and queue lengths, but could also monitor parameters not covered by existing solutions, such as customer satisfaction.

Therefore, there is a need for a system and a method that overcomes the limitations of the prior art and provides additional improvements in a .NET, Web-based queuing system.

### SUMMARY OF THE INVENTION

Accordingly, it is a principal object of the present invention to overcome the limitations of prior art, and to provide additional improvements for Web-based system architecture and a method that is substantially hardware independent for queue management system applications.

It is still a further object of the present invention to provide RFID-based queuing.

It is still another object of the present invention to provide waiting area smart advertising during the queue management process.

It is yet another object of the present invention to provide customer language selection during the queue management process.

It is yet a further object of the present invention to enable the integration of documents into the customer flow.

It is still one more object of the present invention to enable the integration of surveys into the customer flow.

It is yet one more object of the present invention to provide customer flow automation.

It is one added object of the present invention to provide a phone-based agent application during the queue management process.

It is an additional object of the present invention to provide service process recording during the queue management process.

According to a principle embodiment of the present invention, there is provided an improved hardware independent, open-architecture queue management system (QMS) for management of users in a queue, the system including at least one Web-based server for an organization containing the logic and central systems functions. The system also includes a Web client application allowing interaction between the users and the Web Web-based server and accessible through a browser on client workstations and a database installed on a Structured Query Language (SQL) server for record maintenance and interactions with the Web-based server and the client application. The system further includes an announcer server for activating a radio frequency identification (RFID) transmitter carried by each of the users, a survey station kiosk having an RFID receiver, displays to provide queue and marketing information to users and speakers to announce information to the users and an automated an receptionist for issuing tickets to the users.

Additional features and advantages of the invention will become apparent from the following drawings and description.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1 is a schematic illustration of the hardware components comprising one exemplary embodiment of RFID-based queuing, constructed in accordance with the principles of the present invention;

FIG. 2 is a block diagram of the Customer Flow Management Application, modified according to the improvements of the present invention;

FIG. 3 is a flow chart of one exemplary embodiment of the RFID-based reception process, constructed in accordance with the principles of the present invention;

FIG. 4 is a flow chart of one exemplary embodiment of the RFID-based agent approach process, constructed in accordance with the principles of the present invention;

FIG. 5 is a schematic block diagram of one exemplary embodiment of RFID-based directed announcing, constructed in accordance with the principles of the present invention; and

FIG. 6 is a schematic block diagram of one exemplary embodiment of waiting area smart advertising, constructed in accordance with the principles of the present invention.

### DETAILED DESCRIPTION OF THE INVENTION

The invention will now be described in connection with certain preferred embodiments with reference to the following illustrative figures so that it may be more fully understood. References to like numbers indicate like components in all of the figures.

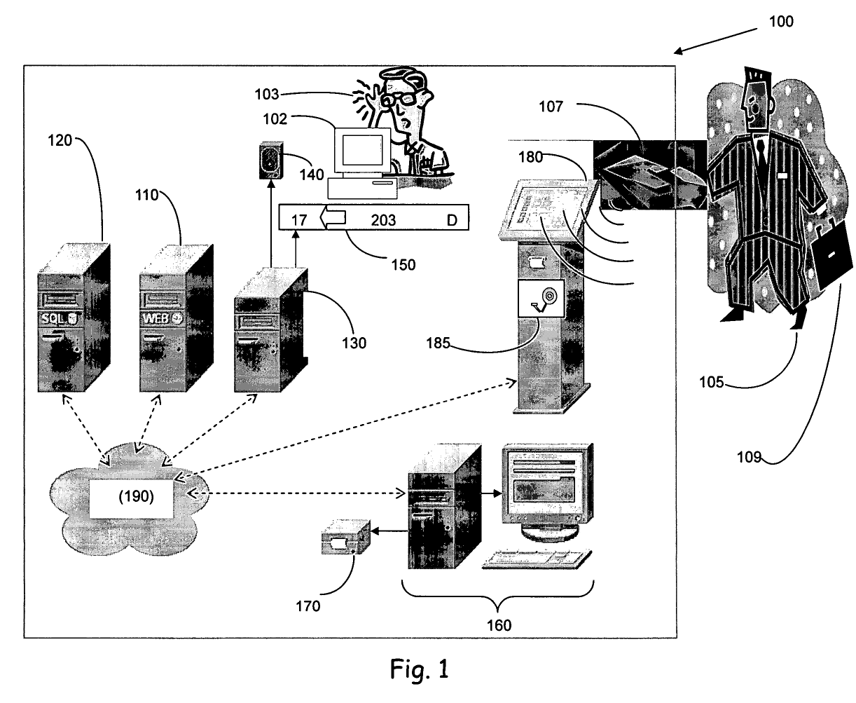

FIG. 1 is a schematic illustration of the hardware components comprising one exemplary embodiment of RFID-based queuing, constructed in accordance with the principles of the present invention. FIG. 1 illustrates the hardware components that are usually found in the QMS environment for servicing users. The environment may contain as many hardware elements, connected through the Web 190, as necessary for each type. A workstation 102 of a service agent 103 can identify customer 105 upon arrival, as described hereinbelow. The user's ID and records may be carried in a briefcase 109, for example, also described below.

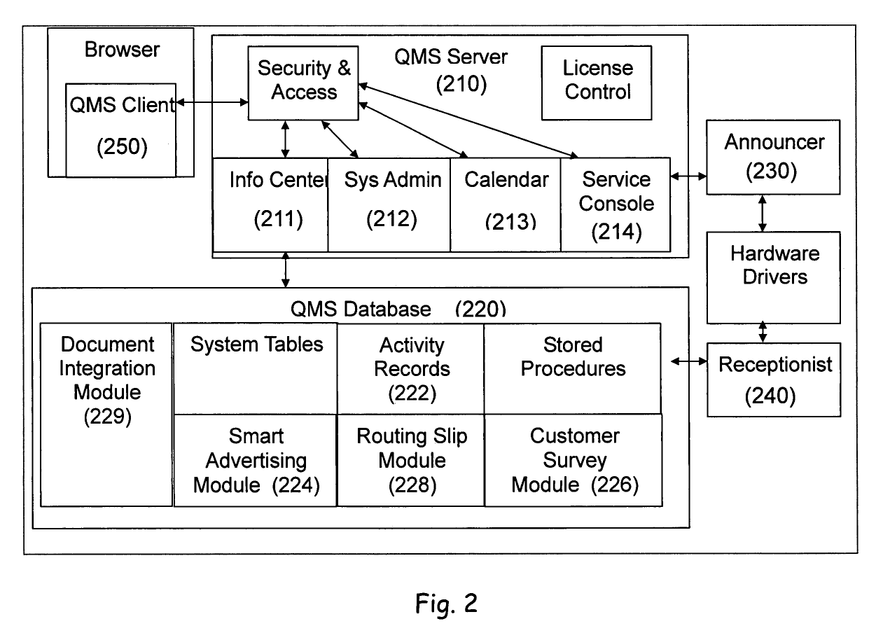

The other hardware components referenced in FIG. 1 are described in combination with the software architecture of FIG. 2.

RFID-Based Queuing

In U.S. patent application Ser. No. 10/628,833, filed Jul. 28, 2003, entitled “A System Architecture And A Method For Customer Flow Management,” hereinafter referred to as the Customer Flow Management Application, the queue management system (QMS) 100 requires the customer/user 105 to actively identify himself, using an ID card 107, a genetic card and/or bar-codes etc., in order for the system to personalize queuing and workflow.

FIG. 2 is a block diagram of the Customer Flow Management Application, modified according to the improvements of the present invention. These are the main 5 software components in QMS:
QMS Server 210 is installed on the Web Server 110 containing the system's “business logic” and performing most central system functions. Comprises 4 main sub-components: Management Information Center 211; System Administration 212; Calendar 213; and Service Console 214;
QMS Database 220 is installed on the Structured Query Language (SQL) Server 120, containing all activity records 222 and performing database-level operations. SQL is a type of programming language used to construct database queries and perform updates and other maintenance of relational databases.
QMS Announcer 230 is installed on the Announcements Server 130, activating LED displays 150 AND speakers 140, as ordered by QMS Server 210;
QMS Receptionist 240 is installed on a survey station/kiosk 180, interacting with arriving customers and issuing them tickets; and
QMS Client 250 is a Web GUI application, allowing interaction between users and QMS Server 210, accessible through browser on client workstations 160, each typically connected to a ticket printer 170.

The present invention provides that QMS survey station/kiosk 180 can identify the customer upon arrival using a short-range, radio frequency identification (RFID) transmitter carried by customer 105, e.g. as part of his ID card 107 and a matching RFID reader/receiver 185 embedded in the survey station/kiosk 180, for example.

The customer RFID could either be a personal RFID identifying the customer, or an item RFID identifying any object carried by the customer which is relevant to queuing and workflow, e.g. a handset ID (when approaching a handset repair service) or a prescription ID (when entering a pharmacy) or any combination of ID's, which are meaningful to the queuing and workflow application, e.g. a VIP customer with a specific type of handset.

The system will then display a personalized welcoming message on the survey station/kiosk screen to customer 105. It will then also provide the customer with either a display of a personalized menu of queuing choices or a personalized ticket directing him to appropriate specific implementation logic.

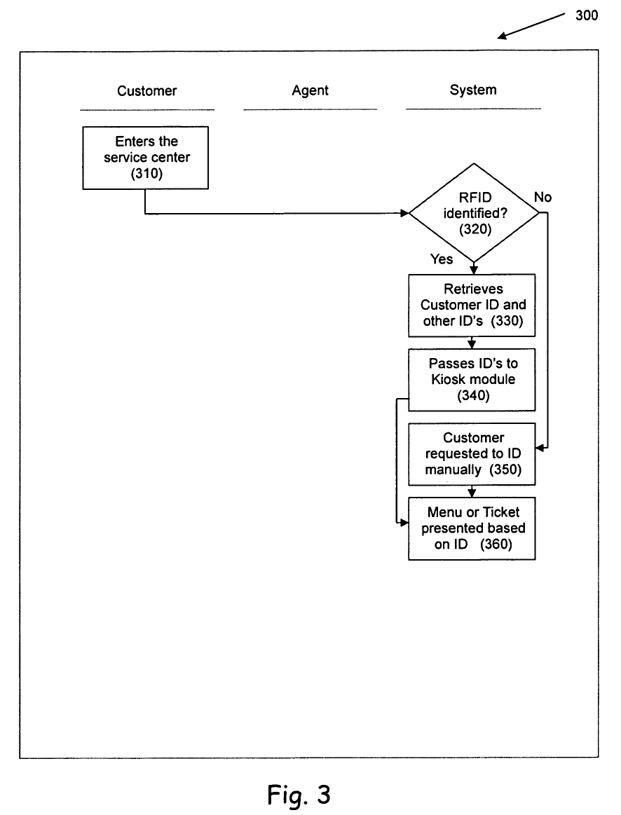

FIG. 3 is a flow chart of one exemplary embodiment of the RFID-based reception process 300, constructed in accordance with the principles of the present invention. A customer enters the QMS service center 310. Then QMS determines whether the customer is currently RFID identified 320. If he is RFID identified, the QMS retrieves his customer ID and any other relevant ID's, such as a social security number or driver's license number 330. The QMS then passes these ID's to the survey station/kiosk 340. If in reference block 320 it is determined that the customer is not currently RFID identified, then QMS asks the customer to identify himself manually 350. Then, in either case, a menu is displayed on the screen of the survey station/kiosk or a ticket is presented to the customer 360.

RFID-Based Agent Application

The Customer Flow Management Application QMS requires a service agent to call the customer and then, optionally, manually confirm the customer's ID by asking him for an ID card, bar-coded document or similar mechanism.

By contrast, the present invention provides that workstation 102 of service agent 103 can identify customer 105 upon arrival, using a short-range RFID transmitter, for example, as part of ID card 107 carried by customer 105, and matching RFID reader/receiver 185, for example embedded in survey station/kiosk 180.

The customer RFID could either be a personal RFID identifying the customer, or an item RFID identifying any object carried by customer 105, which is relevant to queuing and workflow or any combination of ID's which is meaningful to queuing and workflow.

QMS 100 will then be able to automatically confirm that customer 105, who is approaching, is indeed the one called in the case where service agent 103 has previously called for a customer from the queue. QMS 100 can also automatically remove a customer from the queue and start serving him. For example, in case service agent 103 did not call any customer, and the customer approaching is identified as having a place in the queue. Alternatively, QMS 100 can automatically bypass the queuing process and start serving customer 105 as a new case, for example, in case service agent 103 did not call any customer, and the customer approaching is not identified as having a place in the queue.

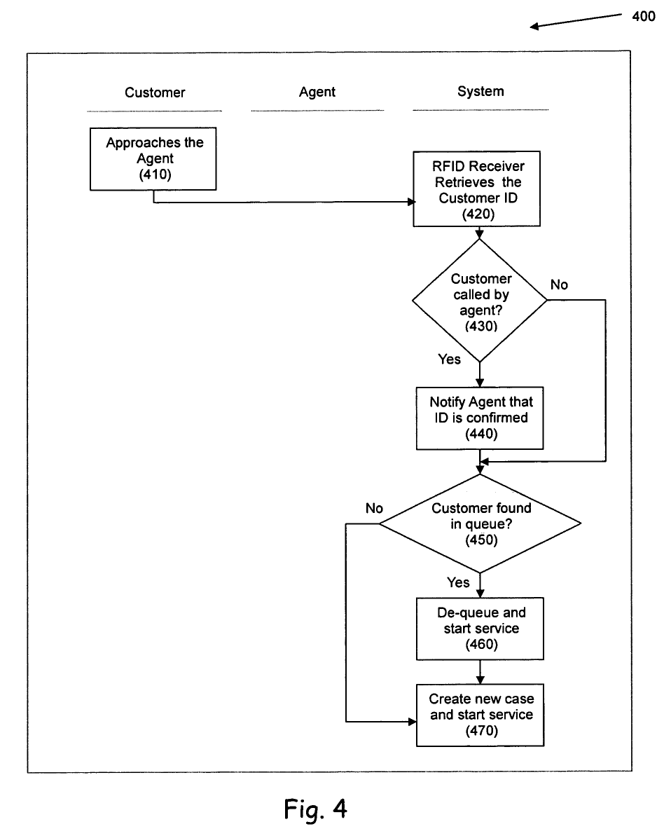

FIG. 4 is a flow chart of one exemplary embodiment of the RFID-based agent approach process 400, constructed in accordance with the principles of the present invention. First, the customer approaches the agent 410. Then the RFID receiver retrieves the customer ID 420. The QMS then automatically decides whether to confirm that customer, who is approaching, is indeed the one called, in the case where the service agent previously called for a customer from the queue 430. If confirmed, QMS notifies the agent that the ID is confirmed 440. If not confirmed, or after notifying the agent that the ID is confirmed, the QMS determines whether the customer approaching the agent actually has a place in the queue at all 450. If the customer does have a place in the queue, the QMS can de-queue the customer and start service 460. If the customer does not have a place in the queue, the QMS can create new case and start service 470.

RFID-Directed Announcing

In the Customer Flow Management Application the QMS activates announcing devices (voice, electronic displays etc.) when an agent calls a customer. When an array of announcing devices is spread between various departments and waiting areas, QMS today chooses which devices to activate based on pre-defined rules, according to where the system expects the customer to be.

By contrast, the present invention provides that agent's workstation 102, for example, can identify the customer's location using a medium-range RFID transmitter carried by customer 105, and matching RFID reader/receiver 185 located in waiting areas.

The customer RFID could either be a personal RFID identifying customer 105, or a temporary RFID embedded in the ticket issued by the receptionist or survey station/kiosk 180.

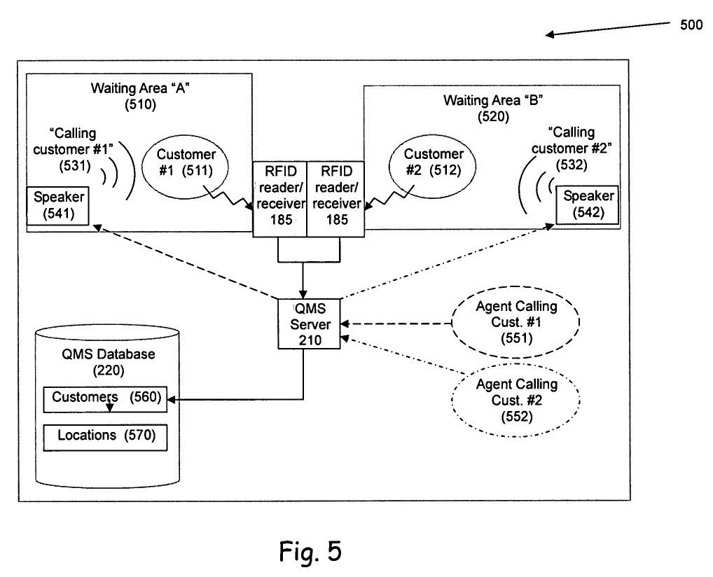

FIG. 5 is a schematic block diagram of one exemplary embodiment of the RFID-based directed announcing 500, constructed in accordance with the principles of the present invention. FIG. 5 shows two waiting areas, a waiting area “A” 510 having a customer #1 511 and a waiting area “B” 520 having a customer #1 512.

QMS 100 is able to automatically tell which announcement device, e.g. speaker 541 or speaker 542, is closest to customers 510 and 520, and activate only the appropriate device or devices when calling a particular customer. QMS will also notify a particular service agent initiating a call 551 or 552 to a particular customer filed in customer records 560 of QMS database 220 as to the present location 570 of the customer, thereby allowing the service agent to estimate the time needed for the customer to arrive from when a particular call 531 or 532 is announced.

Waiting Area Smart Advertising

In the Customer Flow Management Application the waiting area application of the QMS displays a combination of queuing information (next customer, waiting time, etc.) and marketing information, such as advertising, but the queuing information (displayed or internal) does not interact with the ads.

By contrast, the present invention provides that QMS 100 system uses available information regarding the customers currently waiting, to change the marketing information displayed.

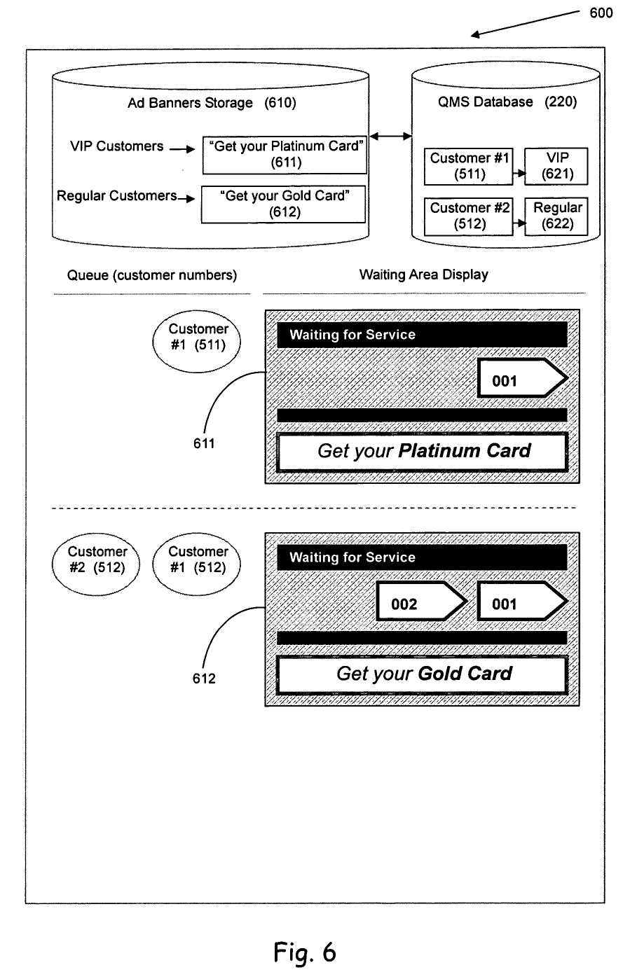

FIG. 6 is a schematic block diagram of one exemplary embodiment of waiting area smart advertising 600, constructed in accordance with the principles of the present invention. The system's smart advertising module 224 of QMS database 220, as referenced earlier in FIG. 2, includes a set of rules which, for different conditions, displays different marketing information onscreen. The conditions look for internal QMS data, such as:

any attributes relating to the customers currently waiting; and

the queues and/or services selected by the customers currently waiting (i.e. for which services are they waiting).

For instance, the rule may be that if the majority of customers waiting are students belonging to the VIP segment 621, as opposed to a regular customer 622, the display would show a commercial for an expensive summer-time vacation. Rules may of course perform any type of logical and arithmetic operations on the attributes of specific customers or, on the average, common or other statistics of waiting customers. This provides for advertising that is more focused and effective.

QMS database 220 has records for VIP customers 621 and regular customers 622, and QMS database 220 may include or be linked to an ad banner storage segment 610, which is shown to include a “Get Your Platinum Card Banner” 611, targeted for VIP customers 511 and a “Get Your Gold Card Banner” 612, targeted for regular customers 512.

Recording the Customer Language Selection

In the Customer Flow Management Application the language selection at QMS kiosks may affect the language of the ticket printed, or allow selection of different queues, e.g. to queue for agents speaking a particular language. If order to queue customers with different languages into one queue, it is not feasible to distinguish between those who chose different languages at the kiosk.

By contrast, the present invention provides that QMS 100 records the language selection made either by customer 105 at survey station/kiosk 180 or by service agent 103 at any stage before or after the service, and attaches the selection to the file record of customer 105.

Once the language is attached to the file record of customer 105, QMS 100 would be able to automatically print the ticket in the chosen language, print personalized messages on that ticket which match the language and call customer 105 using announcements in his own language. In addition, service agents 103 will be able to preview the customer's language before calling him. All this can be done without having to create a separate queue or service for different languages. This enables a more personalized service experience in multi-lingual environments.

Integrating Documents into Customer Flow

In the Customer Flow Management Application the services managed by QMS may require customer 105 to bring documents with him to be handled prior to his service (usually in the back office), during service (usually front office) or following his service (either front or back office). QMS are not integrated with document management systems, and therefore the customer either hands over a paper carried with him, or service agent 103 needs to look up the document manually in a separate document management system or other information system.

By contrast, the present invention provides that documents can be linked to customer 105 in electronic form. Thus, either the actual file may be: carried, e.g., as a diskette or CD in his briefcase 109; a link or a reference may be attached, which can be used by a document management system; or another information system may look up the document. Either the customer record comprising the document goes with customer 105 anywhere or the case record links the document only to a specific visit to customer service. This may occur at any point in the workflow, e.g., when an appointment is made, when customer 105 is transferred from a previous queue, by scanning a document when customer 105 enters a queue, etc.

The document can also be retrieved by any QMS user at any point following the attachment of the document, e.g. by a back office agent (by looking up customer 105 in a “waiting customers list”) or by (front office) service agent 103 (by previewing customer 105 from the waiting list or after calling customer 105 from the list) or by an agent doing follow up. The document, link or reference to it will be accessible by anyone viewing the customer or case details, subject to specified access permissions granted by system administrator 212.

This allows document-dependent workflow to be streamlined and accelerated with less manual work and less room for errors in document retrieval.

It also allows, in cases when the document needs to be processed in the back office prior to calling the customer from the queue (such as preparing a prescription in a pharmacy), to configure the QMS so that back office first pulls the customer document from the queue, performs the pre-processing, then transfers customer 105 to a “ready to call” queue, and then front-desk agent 103 calls only customer 105 from the “ready to call queue.”

Integrating Surveys into Customer Flow

In the Customer Flow Management Application there may be a customer satisfaction survey or other survey to be incorporated into the customer flow, usually following the service. This involves either a small surveying station on agent 103's desk, which is separate from the QMS; or manually sending the customer to a surveying station or survey station/kiosk 180, separate from the QMS; or issuing a ticket with barcode, magnetic stripe or other identification method, which the customer takes to the survey station/kiosk 180. The ticket is then read by survey station/kiosk 180. This allows data analysis to link the survey results with the customer and his QMS records.

By contrast, the present invention provides that survey station/kiosk 180 is linked to QMS 100 by giving it a station ID. Agent 103 can then send customer 105 to survey station/kiosk 180 using the QMS application, just as when transferring customer 105 to another queue. QMS 100 keeps track of customer flow to the station(s), making sure no customer is sent to the station before the previously transferred customer finishes with the survey.

Survey station/kiosk 180 can either be an internal Customer Survey Module 226 of QMS 100 or an external system integrated with QMS 100 to enable QMS 100 to know when customer 105 starts and finishes a survey, and the survey system knows when and which customer 105 is sent to which station.

This ensures customers never wait for the survey station (thus making survey results less affected by such waiting time), frees customers 105 from the need to take tickets to the survey station (thus making the process easier and decreases the number of customers bypassing the survey station). It also creates a direct link between customer 105 and the survey results within QMS 100, making data analysis easier.

Customer Flow Automation

In the Customer Flow Management Application the customer needs to follow a specific route between service departments and the route varies depending on the service or customer. Current QMS requires the agent 103 to manually direct the customer to the next queue based on his knowledge of business processes.

By contrast, the present invention provides a QMS “Routing Slip,” generated by a Routing Slip Module 228, which defines the workflow as a series of enqueuing and transfer commands. E.g.: “enqueue the customer to line 1; when service finished, transfer to line 3; when finished, end process.”

Any customer 105 entering QMS 100 will be associated with either Manual routing (as in the prior art) or a Routing Slip. This will be determined by receptionist 240 or self service survey station/kiosk 180, with the Routing Slip being one of the queuing options (similarly to a simple service selection from reception menus in prior art QMS).

When in Routing Slip mode, all transfer options will be eliminated; when agent 103 ‘Closes’ service or calls the next customer, this will engage the next step in the Routing Slip and notify agent 103 that customer 105 is being transferred. A new QMS application action, “Quit Routing’ will allow agents 103 with permission to revert to Manual mode. Agent 103 will also be able to “Transfer” a customer into a Routing Slip, which will start with the next department to which customer 105 is transferred. This will allow QMS to streamline and eliminate errors in a complex workflow.

Phone-Based Agent Application

In the Customer Flow Management Application QMS and telephony systems are detached. In scenarios where agents perform both face-to-face service and answer the phone, and the business requires that the two types of service do not interfere, it is not feasible to enforce this requirement.

By contrast, the present invention uses the telephone device of agent 103 as the QMS Agent Application. A “bridge application,” referred to hereinafter as the “Bridge,” is programmed that uses real-time API interfaces to communicate with the phone switch. The phone may be an IP phone or non-IP smart phone, for example, with appropriate API interfaces the on one hand and with QMS Server 210 on the other hand.

When agent 103 pushes a phone button pre-assigned as “Next,” the Bridge will activate QMS 100 to call the next customer in line. If so declared by predefined business rules, it will also block the switch from routing calls to that phone and/or block the switch from accepting outgoing calls from that phone.

When agent 103 pushes a phone button pre-assigned as “Close,” for example, the Bridge will activate QMS 100 to end the service operation, and free up the agent's phone for incoming and outgoing calls. Similarly, additional QMS functions may be assigned to other buttons on the phone.

This will enable QMS 100 to operate without tying up workstation 102 of agent 103, or alternatively to operate even without an agent computer, and ensure no interferences during service.

Service Process Recording

In the Customer Flow Management Application, when a recording of the agent-customer interaction is required, Voice & Screen Recording systems, similar to call center systems, are installed, and sometimes integrated with QMS to start and stop recording in sync with the interaction. Call center systems use one voice channel and one screen recording channel per workstation. Alternatively, surveillance recording systems use video channels, but do not sync to screen recording.

By contrast, the present invention provides a QMS-oriented recording installation, which features synchronized recording with 2 voice channels (one microphone facing customer 105 and one facing agent 103), and optionally, a screen channel and/or video channels (one facing customer 105 and one facing agent 103).

The significance of dual voice channels is that it allows better separation of agent and customer voices, plus by subtracting common noise signals from both channels, voice reproduction software will be able to cancel out most noises extraneous to agent 103 or customer 105.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

1. An improved hardware independent, open-architecture queue management system (QMS) for management of users in a queue, said system comprising:
at least one Web-based server for an organization containing the logic and central systems functions;
a Web client application allowing interaction between the users and said web-based server, and accessible through a browser on client workstations;
a database installed on an Structured Query Language (SQL) server for record maintenance and interactions with said web-based server and said client application;
an announcer server for activating at least one of the following:
an radio frequency identification (RFID) transmitter preferably carried by the user to identify the user upon arrival;
a survey station kiosk having an RFID receiver for receiving signals from said RFID transmitter;
displays to provide queue and marketing information to users; and
speakers to announce information to users, according to orders from said at least one Web-based server; and
an automated receptionist for issuing tickets to users, coordinating said transmitter and receiver information and otherwise interacting with the users.

2. The QMS system according to claim 1, based on .NET technology.

3. The system according to claim 1, further comprising a service agent's workstation for personal interaction between a service agent and the user and for integration of said personal interaction with the system.

4. The system according to claim 3, wherein said service agent has a phone device for communication with said at least one Web-based server to perform a bridge application.

5. The system according to claim 5, further comprising a recording installation for providing dual voice channels for better separation of said agent's voice from the user's voice.

6. The system according to claim 1, wherein said survey station kiosk is used to input and record a language selection by the user.

7. The QMS system according to claim 1, said database further comprising a smart advertising module, wherein the QMS system uses available information regarding the users currently waiting to change said marketing information being displayed.

8. The system according to claim 1, said database further comprising a user survey integration module to enable the QMS system to have the user complete a survey and integrate said survey into the system.

9. The system according to claim 8, wherein said survey is a user satisfaction survey.

10. The system according to claim 1, said database further comprising a document integration module providing for the linking of documents to the user in electronic form.

11. The system according to claim 1, said database further comprising a routing slip module providing for defining the workflow as a series of enqueuing and transfer commands.
